(19) United States
(12) Patent Application Publication
(10) Pub. No.: US 2022/0074749 A1
(43) Pub. Date: Mar. 10, 2022

(54) Travel Route Determination and Handling

(71) Applicant: Airvi Inc., Chelmsford (GB)

(72) Inventor: Asher Bennett, Chelmsford (GB)

(21) Appl. No.: 17/416,626

(22) PCT Filed: Dec. 23, 2019
(86) PCT No.: PCT/EP2019/086981

§ 371 Date: Jun. 21, 2021

(30) Foreign Application Priority Data
Dec. 21, 2018 (GB) 1820986.6
Feb. 1, 2019 (GB) 1901442.2

(51) Int. Cl. G01C 21/34; G06Q 50/30; G06Q 30/00; G06K 9/32; G06K 9/00

(52) U.S. Cl. CPC G01C 21/3407; G06Q 50/30; G06Q 30/0284; G06K 9/325; G06K 9/00664; G06Q 30/018

(57) ABSTRACT

Apparatus is configured to: receive a current location and a planned destination from a plurality of mobile devices; plan travel routes for each of the plurality of mobile devices, based at least on the current locations and planned destinations, that reduce congestion and/or improve air quality in a geographical area, and communicate the planned travel route to the associated mobile device.

The invention relates to a method and apparatus for determining and handling travel options (e.g. travel routes) which reduce congestion and/or improve air quality. Aspects of the invention also relate to the implementation of virtual clean air and congestion zones.

Traffic congestion and road transportation emissions are a huge global problem. Congestion zones are a good solution, in principle, but in practice are prohibitively expensive to set up. For example, the set up cost of the London congestion zone was approximately £170 million. As a result, it is estimated that less than 10 congestion zones exist worldwide. Furthermore, despite the extreme cost required to set up congestion zones, they are primitive in their operation (e.g. with set boundaries where the fixed cameras are, predetermined times of operation, and charge a single fee irrespective of how far a vehicle travels through the zone, or whether a journey actually contributed to congestion).

Clean air zones are becoming more prevalent worldwide but are also primitive in their operation. For example, some clean air zones require a badge on a windscreen denoting a vehicle's emission level combined with random police checks. Clean air zones also suffer from being rigid in geography and not flexible to adapt to the actual pollution levels present in the area at a particular time. A fixed-camera-based system for enforcement is also prohibitively expensive.

Causes of congestion in some areas include mapping and navigation systems which provide mobile devices with the quickest route to their destinations.

Efforts are being made to address the current issues associated with congestion and pollution. Examples include car-pool lanes and bus lanes. However, these are inflexible and often result in unused (i.e. wasted) space on the roads, as well as being difficult to enforce without significant infrastructure and/or labour costs. Other examples include creating underground tunnel systems so as to reduce congestion above ground, and creating flying taxis to avoid congestion from occurring at ground level. However, as with the creation of congestion zones and clean air zones, these proposals for controlling congestion and pollution require extreme expense to implement.

The present invention aims to alleviate at least some of the aforementioned problems.

According to an aspect of the invention, there is provided a method comprising: receiving a current location and a planned destination from a plurality of mobile devices; planning travel routes for each of the plurality of mobile devices, based at least on the current locations and planned destinations, that reduce congestion and/or improve air quality in a geographical area, and communicating the planned travel route to the associated mobile device.

The method may comprise planning more than one travel route for each of the plurality of mobile devices and assigning a priority level to each planned route.

The method may further comprise receiving information indicating modes of transport of the plurality of mobile devices, wherein the assigning the priority levels is based on the modes of transport.

The method may further comprise receiving air quality information for the geographical area from an air quality server, wherein the assigning the priority levels is based on the air quality information.

The priority level for each planned route may indicate a required minimum number of people per vehicle for that route.

The priority level for each planned route may indicate a maximum emission level for a vehicle for that route.

The method may further comprise receiving compliance data from the plurality of mobile devices; and determining whether a mobile device is following a permitted route based on the compliance data.

The compliance data may comprise location-related data received at the mobile device.

The compliance data may comprise information relating to images captured by at least one of the plurality of mobile devices.

The compliance data may comprise microphone and/or accelerometer data from the plurality of mobile devices.

The determining whether the mobile device is following the permitted route may be based on compliance data received by the coordination server from another mobile device from among the plurality of mobile devices.

The compliance data received from the another mobile device may comprise information indicating that the another mobile device has identified a vehicle associated with the mobile device near to a location of the another mobile device.

The compliance data may comprise automatic number plate recognition, ANPR, data.

The method may further comprise assigning a confidence level to the compliance data for the mobile device based on a quantity of ANPR data corresponding to the mobile device The method may further comprise determining a preferred operational mode for driving a vehicle along the planned route for at least one of the plurality of mobile devices.

The method may further comprise determining whether the vehicle is operating in the preferred operational mode based on the microphone and/or accelerometer data.

The method may further comprise receiving, from one of the plurality of mobile devices, traffic information comprising an identity and approximate location of one or more vehicles, the traffic information being derived from an image captured by the mobile device; and updating the planned travel routes based on the current location of the mobile device and the generated traffic information.

The method may further comprise receiving parking space information indicating a location of an available parking space from a first mobile device from among the plurality of mobile devices, the parking space information being derived from an image captured by the first mobile device, and setting a final destination of a planned travel route for a second mobile device from among the plurality of mobile devices as the location of the available parking space.

According to an aspect of the invention, there is provided an apparatus is configured to perform any one of the discussed methods.

According to an aspect of the invention, there is provided a computer program comprising machine-readable instructions which, when executed by computing apparatus, cause it to perform any one of the discussed methods.

According to an aspect of the invention, there is provided an apparatus configured to: receive a current location and a planned destination from a plurality of mobile devices; plan travel routes for each of the plurality of mobile devices, based at least on the current locations and planned destinations, that reduce congestion and/or improve air quality in a geographical area, and communicate the planned travel route to the associated mobile device.

According to an aspect of the invention, there is provided an apparatus configured to: in response to receiving, location information for a target destination, request from a server, navigation information for driving a vehicle to the target destination, the navigation information including route information and operation information indicating a preferred operational mode for the vehicle; and in response to receiving the navigation information, collect compliance data indicating compliance of the vehicle with the navigation information and transmitting the compliance data to the server.

According to an aspect of the invention, there is provided an apparatus configured to: detect a current location of the apparatus; capture an image, using a camera of the apparatus; generate, from the captured image, traffic information comprising a determined identity and approximate location of one or more vehicles in the captured image; transmit, to a server, the current location of the apparatus and the generated traffic information; and request, from the server, updated navigation information based on the current location of the apparatus and the generated traffic information.

According to an aspect of the invention, there is provided an apparatus configured to: detect a current location of the apparatus; capture an image, using a camera of the apparatus; determine an approximate location of a parking space in the captured image; determine, based on the current location of the apparatus, and the approximate location of the parking space in the image, the physical location of the parking space.

According to an aspect of the invention, there is provided a coordination server for planning travel routes of a plurality of mobile devices in a geographical area, comprising: a communication interface arranged to receive location-related data from the plurality of mobile devices; and a processor arranged to: determine a travel route for each of the plurality of mobile devices, based on the location-related data, to reduce congestion and/or improve air quality in the geographical area, and control the communication interface to transmit the determined travel route for each mobile device to said mobile device.

The location-related data may comprise a current location of a mobile device.

The location-related data may include a planned destination of a mobile device.

The processor may be arranged to determine more than one travel route for each of the plurality of mobile devices and to assign a priority level to each determined route.

The communication interface may be further arranged to receive information indicating modes of transport of the plurality of mobile devices; and the assignment of priority levels may be based on the modes of transport.

The communication interface may be further arranged to receive air quality information for the geographical area from an air quality server; and the assignment of priority levels may be based on the air quality information.

The priority level for each determined route may indicate a required minimum number of people per vehicle for that route.

The priority level for each determined route may indicate a maximum emission level for a vehicle for that route.

The communication interface may be configured to receive compliance information from the plurality of mobile devices, and the processor may be configured to determine whether a mobile device is following a permitted route based on the compliance data.

The compliance data may comprise location-related data received at the mobile device.

The compliance data may comprise information relating to images captured by at least one of the plurality of mobile devices.

The compliance data may comprise microphone and/or accelerometer data from the plurality of mobile devices.

The processor may be configured to determine whether the mobile device is following the permitted route based on compliance data received by the coordination server from another mobile device from among the plurality of mobile devices.

The compliance data received from the another mobile device may comprise information indicating that the another mobile device has identified a vehicle associated with the mobile device near to the location of the another mobile device.

The compliance data may comprise automatic number plate recognition, ANPR, data.

The coordination server may be configured to assign a confidence level to the compliance data for the mobile device based on a quantity of ANPR data corresponding to the mobile device.

The processor may be further arranged to determine a preferred operational mode for driving a vehicle along the determined route for at least one of the plurality of mobile devices.

The compliance data may comprise microphone and/or accelerometer data indicating an active operational mode of the vehicle.

The communication interface may be further arranged to receive parking space information indicating a location of an available parking space from a first mobile device from among the plurality of mobile devices, the parking space information being derived from an image captured by the first mobile device, and the processor may be further arranged to set a final destination of a determined travel route for a second mobile device from among the plurality of mobile devices as the location of the available parking space.

According to an aspect of the invention, there is provided a computer-implemented method comprising: in response to receiving, by a mobile device, location information for a target destination, requesting, by the mobile device from a server, navigation information for driving a vehicle to the target destination, the navigation information including route information and operation information indicating a preferred operational mode for the vehicle; and in response to receiving the navigation information, collecting, by the mobile device, compliance data indicating compliance of the vehicle with the navigation information and transmitting the compliance data from the mobile device to the server.

Collecting the compliance data may comprise detecting, by the mobile device, a location of the mobile device.

Collecting the compliance data may comprise detecting, by the mobile device using a microphone and/or accelerometer of the mobile device, an active operational mode of the vehicle.

According to an aspect of the invention, there is provided a computer-implemented method comprising: detecting, by a mobile device, a current location of a mobile device; capturing an image, using a camera of the mobile device; generating, by the mobile device from the captured image, traffic information comprising a determined identity and approximate location of one or more vehicles in the captured image; transmitting, by the mobile device to a server, the current location of the mobile device and the generated traffic information; and requesting, by the mobile device from the server, updated navigation information based on the current location of the mobile device and the generated traffic information.

According to an aspect of the invention, there is provided a computer-implemented method comprising detecting a current location of a mobile device; capturing an image, using a camera of the mobile device; determining an approximate location of a parking space in the captured image; determining, based on the current location of the mobile device, and the approximate location of the parking space in the image, the physical location of the parking space.

Many other features, applications, embodiments, and/or variations of the disclosure will be apparent from the accompanying drawings and from the following detailed description. It should be appreciated that alternative and/or additional implementations of the systems, non-transitory computer readable media, and methods described herein can be employed without departing from the principles of the disclosure.

Embodiments according to the invention are in particular disclosed in the attached claims directed to a system, method and a computer program product, and any feature mentioned in one claim category, e.g. method, can be claimed in another claim category, e.g. system, as well.

Embodiments of the present invention will now be described, by way of example only, with reference to the accompanying drawings, in which:

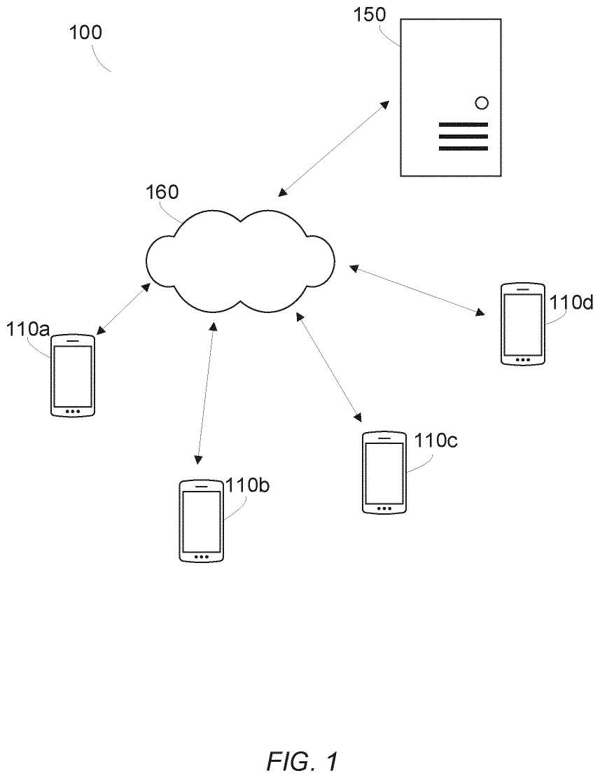

FIG. 1 shows a schematic illustration of a system according to a first embodiment of the invention;

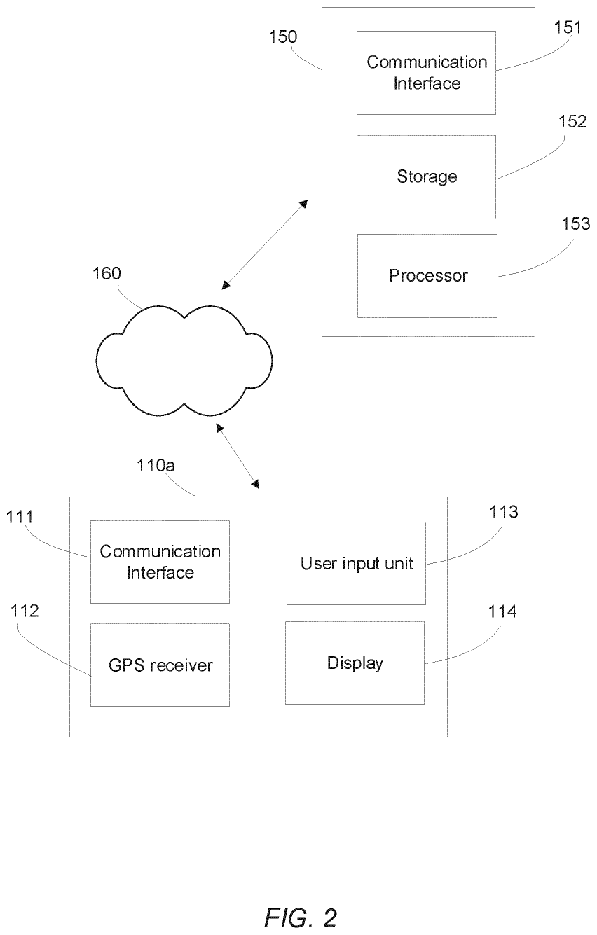

FIG. 2 shows a schematic illustration of a system according to the first embodiment of the invention;

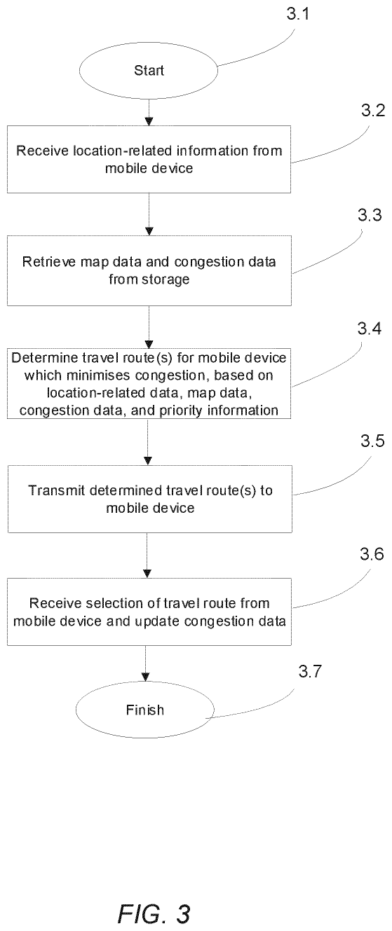

FIG. 3 shows a flow chart of the operation of the first embodiment;

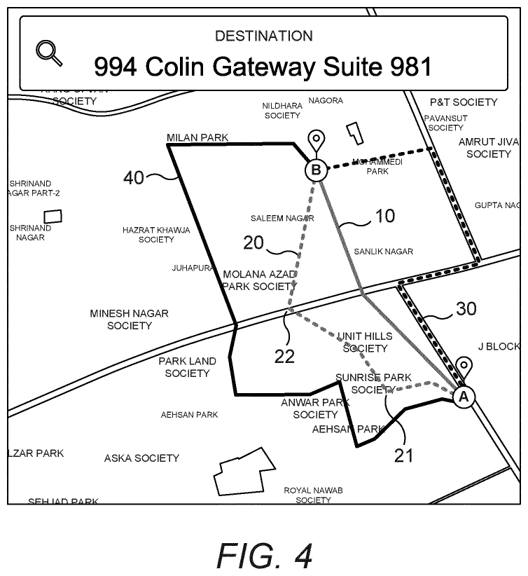

FIG. 4 shows an example operation of the first embodiment;

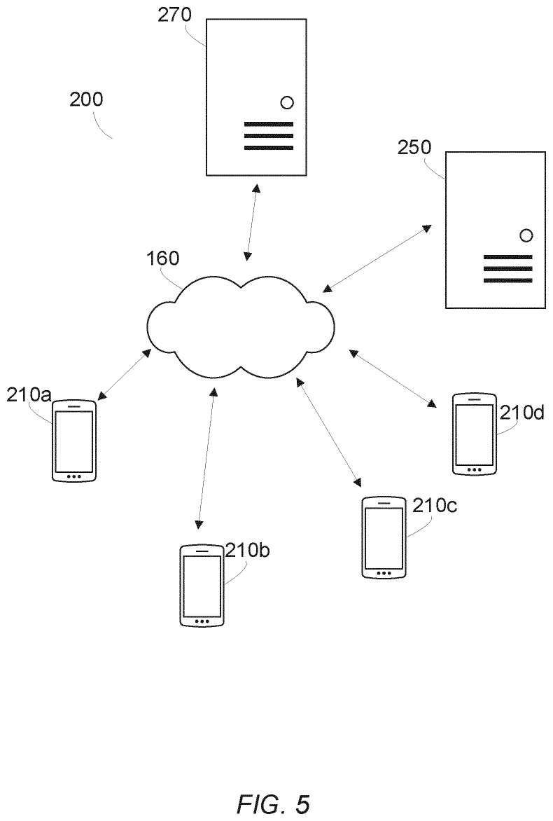

FIG. 5 shows a schematic illustration of a system according to a second embodiment of the invention;

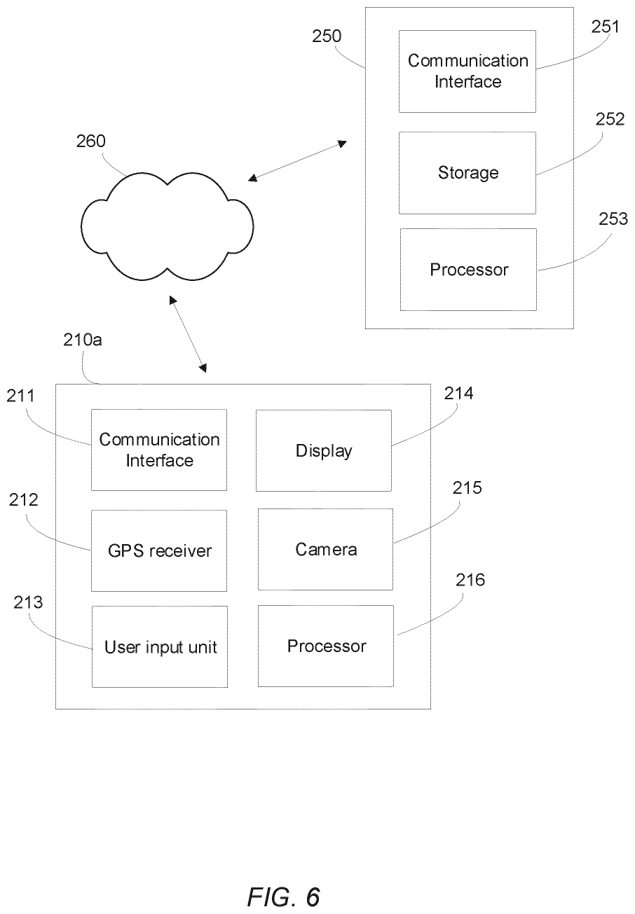

FIG. 6 shows a schematic illustration of a system according to the second embodiment of the invention;

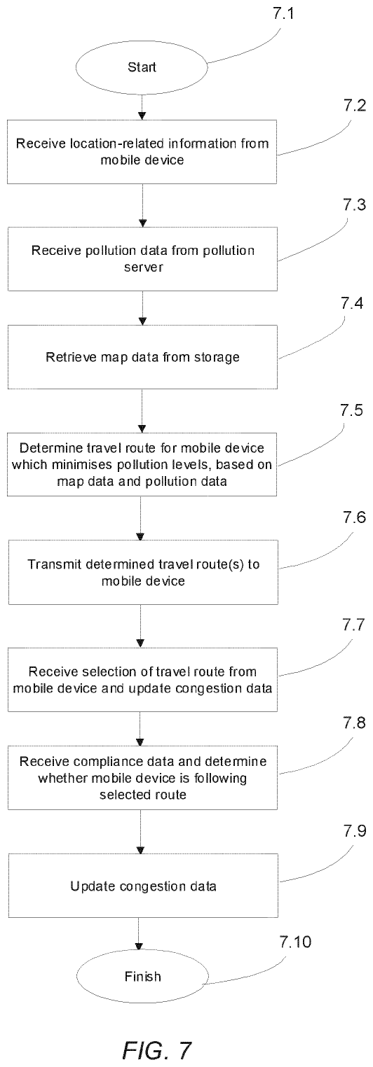

FIG. 7 shows a flow chart of the operation of the second embodiment.

In brief, embodiments of the invention provide methods of providing navigation suggestions for a plurality of users within a zone (e.g. a city). By taking a holistic view of the users' planned journeys within the zone, the journeys can be coordinated so as to provide navigation suggestions which help to alleviate congestion and/or pollution within the zone. By coordinating the journeys of a number of users, the method provides for a greater effect in reduction in congestion and/or improvement in air quality than could be achieved through uncoordinated travel route planning of the multiple journeys.

In some embodiments, the method is focused on reducing congestion, and the users' journeys are coordinated so as to prevent a build-up of traffic in a particular location within the zone. Furthermore, by reducing congestion, air quality in the geographical area (e.g. city) can be improved since there are fewer circumstances in which vehicles are static in traffic jams, which would ordinarily result in higher levels of pollution. Different suggestions can be given for different modes of transport. For example, a mode with a high density of passengers (such as a bus or coach) could be suggested a more direct travel route, whereas a car with a single person inside could be suggested a longer route which avoids congested areas.

Other embodiments focus on improving air quality (reducing pollution) in the zone. When focusing on air quality, the methods can involve suggesting different navigation options for users based on modes of transport. For example, for a user driving an electric car the fastest route might be suggested to the user since this has zero emissions and does not contribute to pollution, whereas a longer route which avoids pollution hotspots might be suggested to a user driving a diesel car. Furthermore, live pollution data for the zone can be obtained, so that navigation suggestions can be dynamically determined based on live pollution levels at different points within the zone.

In some embodiments, the balance between a focus on congestion and a focus on air pollution can be varied dynamically (e.g. focus on reducing congestion during rush hour, and focus on improving air quality for the rest of the day).

When determining navigation suggestions to provide to users, multiple different routes are assessed. In some embodiments, the different routes are assigned different levels based on their impact on congestion and/or air quality, and appropriate suggestions can be made to users. In some embodiments, a user can be provided with multiple navigation suggestions, with different requirements for each one. For example, a direct route could be suggested in with the requirement that they take a bus along the route, and a less direct route could be suggested along which they can drive their car, thereby encouraging the use of transport modes which have less impact on congestion and/or pollution in return for being able to have a quicker journey.

Some embodiments can involve tracking users during their journeys, so as to determine whether they are following the suggestions. This can involve receiving data from devices such as users' smartphones. For example, GPS data can be used to assess a user's location, while accelerometer data can be used to determine a mode of transport (e.g. whether they are walking or cycling). In other embodiments, microphone and/or accelerometer data can be used to asses vibration levels so as to determine the mode of transport, such as whether or not a hybrid vehicle is operating in its electric mode.

Some embodiments involve user's mobile devices (such as smartphones) being used as dashboard cameras, to photograph and identify other vehicles (e.g. using ANPR). This information can then be used to determine whether other users are following their suggested routes. Hence, while there may be doubt as to whether a user is providing legitimate proof of their own journey, this can be verified by using data from a different independent user, without the need for separate infrastructure (such as fixed cameras).

When acting as dashboard cameras, users' mobile devices can also be used to monitor and report traffic conditions, as well as to identify and report available parking spaces. This information can be used, for example, to direct users straight to available parking spaces so as to prevent user's unnecessarily driving around trying to find parking spaces, thus further reducing congestion.

Planning travel routes which reduce congestion and/or improve air quality involves planning travel routes for the plurality of mobile devices which results in less overall congestion and/or better air quality in the geographical area than if each mobile device followed the shortest, fastest, or easiest route available to its planned destination. Such planning of travel routes for the plurality of mobile devices allows coordination, with a greater effect in reduction in congestion and/or improvement in air quality than could be achieved through uncoordinated travel route planning of the multiple journeys.

FIG. 1 shows a system 100 according to a first embodiment. The system comprises a plurality of mobile devices 110a, 110b, 110c, 110d and a coordination server 150. The plurality of mobile devices 110a, 110b, 110c, 110d can communicate with the coordination server 150 via the network 160. It will be appreciated that in practical implementations of embodiments of the invention there may be many such mobile devices, but four such mobile devices will be described in relation to FIG. 1 for ease of explanation.

FIG. 2 shows more detail regarding one mobile device 110a of the plurality of mobile devices and the coordination server 150. The mobile device 110a comprises a communication interface 111, a Global Positioning System (GPS) receiver 112, a user input unit 113, and a display 114. The other mobile devices in the system 100 comprise equivalent components.

The communication interface 111 is configured to communicate with a communication interface of the server 150 via the network 160. Specifically, the communication unit 111 is configured to transmit location-related data to the server 250 and receive determined travel routes from the coordination server.

The GPS receiver 112 is configured to receive GPS data from a plurality of GPS satellites, and to process the received GPS data to determine a location of the mobile device 110a. While in this embodiment, the mobile device 110a comprises a GPS receiver, embodiments of the invention are not limited to this. A GPS receiver is an example of a location-determination module, and it will be appreciated that any other such location-determination module could be included in addition, or instead. For example, any other form of Global Navigation Satellite System (GNSS) receiver could be used. This includes any one or combination of GPS, Global Navigation Satellite System (GLONASS), the European Galileo system or the Chinese BeiDou Navigation Satellite. In addition, in some embodiments, the mobile devices could be capable of determining their locations through other means, including using Wi-Fi signals and through a camera included in the mobile devices. Some of these will be discussed in more detail later.

The user input unit 113 is configured to receive an input from a user of the mobile device. In this embodiment, the user input unit is a touch screen on the display 114. However, embodiments of the invention are not limited to this and the user input unit in other embodiments could be any other component capable of receiving a user input (e.g. microphone, camera, physical button etc.).

The display 114 is configured to display information for a user of the mobile device. Specifically, the display 114 is configured to display information regarding determined travel routes received from the server 150 through the communication interface 111.

In this embodiment, the mobile device 110a is a smartphone, as are the other mobile devices in the system 100. However, embodiments of the invention are not limited to this and the mobile devices could be any suitable mobile device. Examples include tablets, laptops, PDAs etc. Alternatively, the components of the mobile device could be integrated into a vehicle, such as a car.

The coordination server 150 comprises a communication interface 151, a storage unit 152 and a processor 153. In this embodiment, the coordination server 150 is a single apparatus. However, embodiments of the invention are not limited to this and the server functionality of other embodiments could be provided in more than one connected apparatus.

The communication interface 151 of the coordination server 150 is configured to communicate with the plurality of mobile devices 110a, 110b, 110c, 110d. Specifically, the communication interface 151 is configured to receive location-related data from the plurality of mobile devices 110a, 110b, 110c, 110d and to transmit determined travel routes to the plurality of mobile devices 110a, 110b, 110c, 110d.

The storage unit 152 of the coordination server 150 pre-stores user information. Specifically, each mobile device in the system is associated with a particular user. In this embodiment, this information is input by the user when they first register their mobile device into the system. However embodiments of the invention are not limited to this, and in other embodiments, this information could instead be transmitted from the user's mobile device to the coordination server each time it is needed.

In this embodiment, the storage unit 152 of the coordination server 150 also stores map data, including information such as speed limits for each of the roads in the map. In addition, the storage unit 152 stores congestion data, including the (actual or predicted) location and travel route of each of the mobile devices in the system. This information is received from the mobile devices, as discussed further later.

The processor 153 of the server 150 is configured to process information received through the communication interface 151 and information stored in the storage 152, so as to determine at least one travel routes for the plurality of mobile devices. The specific operation of the processor 153 will be discussed in detail later.

The network 160 in this embodiment is the internet. However, embodiments of the invention are not limited to this and any suitable communication technology could be used instead. Examples include an intranet/private network or a cellular network.

The coordination server 150 is arranged to determine travel options (e.g. routes) for the mobile devices in the system. Specifically, the coordination server 150 is configured to provide one or more travel routes for at least one of the mobile devices in the system. According to an embodiment, the travel routes are determined with the aim of reducing congestion in a geographical area (e.g. city) in which the mobile devices are located. As will be discussed in detail, when determining the travel route for a mobile device in the system, the coordination server may use any of location-related data of the mobile device (e.g. current location and destination), location-related data of the plurality of mobile devices in the system, congestion data for the geographical area and priority related information for the mobile device (e.g. how many people are travelling together and in what type of vehicle).

Embodiments of the invention use a holistic approach to determine travel routes which minimise overall congestion. This can result in a quicker average travel time (i.e. quicker average for all users) as well as a reduction in pollution, and therefore an increase in air quality.

The operation of the embodiment discussed in relation to FIGS. 1 and 2 will be explained in relation to the flow chart of FIG. 3, which shows operations of the coordination server 150 with respect each mobile device in the system 100.

The method starts at step 3.1.

At step 3.2, the communication interface 151 of the coordination server 150 receives location-related data from a mobile device. In this embodiment, the location-related data is a current location of the mobile device and a destination.

At step 3.3, the processor 153 of the coordination server 150 retrieves the map data and congestion data from the storage. The map data is data which is pre-stored in the storage 152. The congestion data includes a current (actual or predicted) location and/or travel route of each mobile device in the system. The acquisition and updating of the congestion data will be discussed later with reference to step 3.5.

At step 3.4, the processor 153 of the coordination server 150 determines possible travel routes for the user of the mobile device to use to travel from their current location to their destination. The coordination server 150 is configured to determine possible travel routes which reduce overall congestion (and therefore reducing the overall average travel time) rather than simply providing the user with the quickest possible travel route.

In this embodiment, the coordination server 150 determines a plurality of possible routes between the current location of a mobile device and its destination, and assigns a priority level to each route. For example, the quickest, most direct route, which is prone to congestion, is given a high priority level, whereas a longer route which uses quieter roads is assigned a low priority level. The user of the mobile device is encouraged to use high-priority transport modes for routes with a high-priority level. In some examples, only high priority modes of transport are permitted/encouraged to use high priority routes. Furthermore, as discussed in more detail later, in some embodiments, the coordination server 150 can generate transport routes for a mobile device according to the priority of known transport modes of that device (e.g. if a user is driving in a car on their own, the coordination server would only generate travel routes with a low priority levels corresponding to the priority of that mode of transport).

In this embodiment, the priority of a device's (and therefore user's) mode of transport is based on a person density per vehicle. For example, each device in a bus with 20 people on board would have a much higher priority than a device in a car with only one person inside. The quickest, most direct route may require the user to travel in a high priority mode (e.g. bus), whereas if the user wants to drive their car (and therefore have a lower person density per vehicle), they would be required to use a longer, lower priority route.

The coordination server 150 of this embodiment is able to dynamically determine travel routes and priorities based on current travel information (from the congestion data). By assigning priority levels, for example, based on passenger density, the person-flow through the network can be improved, resulting in a more efficient transport network. Specifically, by requiring a high priority (i.e. large number of people per vehicle), the coordination server is able to provide maximum throughput on the most direct routes and hence makes the best use of the network capacity.

At step 3.5, the communication interface 151 of the coordination server 150 transmits the determined routes, as well as their respective priority requirements, to the mobile device. For example, the coordination server 150 may provide the mobile device with three routes. The priority requirement of the quickest, most direct route could be such that the user must travel in a vehicle such as a coach or a bus to meet the priority level. For the second route, which is slightly longer and uses fewer roads prone to congestion, the user may drive their vehicle (e.g. car) and meet the priority level if there are at least two people in their vehicle (e.g. because they are travelling with another person or because they pick up a car-pooler en route). Finally, the third route may be significantly longer and only use quiet roads, allowing the user to drive their car on their own and meet the priority level.

At the mobile device the user can then select which route to take. In this embodiment, the user selects their route using the user input unit (i.e. touch screen) of their mobile device. The mobile device then transmits the selected route back to the coordination server 150 at step 3.6. The coordination server 150 uses this information to update its congestion data. In particular, the coordination server 150 updates the current location and current travel route of that mobile device.

In this embodiment, the coordination server 150 then uses this information to predict locations (at other times) of the mobile device along its route, based on the stored congestion data and the time. However, embodiments of the invention are not limited to this. For example, in other embodiments, the mobile device may periodically transmit location data (e.g. from its GPS receiver) to the coordination server along its route. Furthermore, as discussed in detail later, in some embodiments the mobile device may be required to ‘prove’ that it is following the selected route.

The method finishes at step 3.7.

While the method of FIG. 3 has been discussed with relation to providing travel routes for a single mobile device, it will be appreciated that in practical implementations of embodiments of the invention, the coordination server is likely to perform the method of FIG. 3 a large number of times, for many mobile devices, often simultaneously.

FIG. 4 shows an example of the travel routes determined by the coordination server at step 3.4 of FIG. 3. The example of FIG. 4 will now be discussed with reference to the method of FIG. 3.

Prior to the method starting, a user's mobile device 110a (smartphone in this example) determines its current location using a GPS receiver. The current location of the smartphone in this example is point A shown in the map of FIG. 4. The user inputs their destination address at their smartphone. The destination address in this example is point B in the map of FIG. 4.

The method at the coordination server then starts at step 3.1.

At step 3.2, the coordination server 150 receives the location related information from the smartphone. In other words, the coordination server 150 receives information indicating that the smartphone 110a is currently at point A and has a destination address of point B.

At step 3.2, the coordination server 150 retrieves the map data and congestion data relevant for the route between point A and point B (e.g. data relating to the map shown in FIG. 4). Then, at step 3.4 the coordination server 150 determines possible travel routes for the user of the smartphone to travel from point A to point B. Specifically, as shown in FIG. 4, the coordination server 150 determines four travel routes.

Based on the length of each route and the current congestion data, the coordination server 150 determines that the first travel route 10 would be the quickest, the second travel route 20 would be the second quickest, the third travel route 30 would be the third quickest and the fourth travel route 40 would be the slowest.

The coordination server 150 is configured to minimise congestion occurring. The coordination server 150 distributes the traffic in the geographical area by using all of the available routes, thereby avoiding congestion from occurring at any particular point.

For example, the coordination server 150 could designate the first route 10 as very high priority, indicating that vehicles which do not have a very high person density per vehicle (e.g. cars carrying only one or two people)) are encouraged (or influenced) not to use this route.

The coordination server 150 then designates the second route 20 as high priority (i.e. encouraged to have at least four people per vehicle in this example), the third route 30 as medium priority (i.e. encouraged to have at least two people per vehicle), and the fourth route 40 as low priority (i.e. anybody can use this route).

At step 3.5, the coordination server 150 transmits the routes and the priority information to the smartphone 110a. The user of the smartphone 110a can then decide which route to take. If the user wants to use the quickest route (i.e. the first route 10) they are encouraged to take a bus or a coach. In variants of this embodiment, the coordination server also stores bus timetable information and transmits this to the smartphone together with the possible routes. The bus timetable information can also be used to determine the possible routes and their priority levels. For example, the first route 10 would only be designated a very high priority (indicating only buses and/or coaches can use it) if a bus and/or coach actually travels along that route.

In the example of FIG. 4, if the user wants to drive their own car, they would be encouraged to follow the second route 20, third route 30 or fourth route 40. If the user is travelling with at least three other people (i.e. four people in total), they could use the second route. Similarly, if the user is travelling with at least one other person (i.e. two people in total), they could use the third route 30, and if they are travelling alone, they are encouraged to use the fourth route 40.

As shown in FIG. 4, the fourth route 40 is a long route which only uses quiet roads. Hence, by taking this route, the user does not contribute to congestion on any major/busy roads.

At step 3.6, the coordination server 150 would receive the user's selection and store this in its storage unit 152 as congestion data.

In this embodiment of the invention, by spreading the flow of traffic along all of the routes, congestion is avoided altogether (or at least dramatically reduced). In addition, by requiring a larger number of people per vehicle for the quicker routes, the system encourages the use of public transport (i.e. buses) and car-pooling. This results in fewer vehicles being on the roads overall, thereby reducing congestion.

In a variant of this embodiment, the use of car-pooling can be further encouraged. For instance, in the example of FIG. 4 (which requires at least 4 people in total to use the second route 20), at step 3.5 the coordination server could also transmit information regarding car-pooling options. For example, the coordination server could transmit information indicating that three people want to travel from location 21 to location 22 in FIG. 4. As such, the user of the smartphone would be permitted to travel along the second route 20, provided they picked up the three people at location 21 and dropped them off at location 22. Hence, by providing the incentive of reduced total travel time, a user can be encouraged to take part in car-pooling and thereby reduce congestion.

In another variant of this embodiment, the coordination server can also transmit different timings to the mobile device, along with the determined routes and priority information. For example, the coordination server could determine the quickest route (e.g. the first route 10 of FIG. 4), as very high priority (i.e. only buses and coaches) when a user first requests a travel route at 8:30 am (i.e. during rush hour), but could also provide a prediction (based on history information stored in the storage) that at 10:00 am (i.e. after rush hour), the priority level would be reduced. Hence a user could defer their journey, and take the faster route at a later time. In some embodiments, suggestions could also be based on a user's registered, or usual, routes. For example, if a user often goes to the same place at the same time (e.g. commuting to work), travel options for this could be automatically determined.

In another variant of this embodiment, the suggested routes could include more than one mode of transport (i.e. suggest multimodal routes). For example, the coordination server could determine a travel route as car-pooling to a train station and then taking a train to the final destination.

In yet another variant of this embodiment, the location-related information received from the mobile device at step 3.2 of FIG. 3 could include a user's desired travel needs for a day (i.e. everywhere they wish to travel to during the day). The coordination server could then provide optimum travel routes and timings which allow the user to take the shortest possible journeys according to their needs.

Furthermore, in variants of this embodiment, the congestion data could be received from an external source (e.g. external congestion server), in addition to, or instead of, compiling congestion data based on current locations and travel routes received from mobile devices in the system. Such an external server is particularly beneficial in scenarios in which a large number of mobile devices in a given geographical area (e.g. city) are not a part of the system.

In another variant of this embodiment, a user can pay to increase their priority level. For example, if a route could require a person density per vehicle of four, but this could be reduced to three (or two or one) if a user paid (e.g. £1). In some variants, the priority could be based only on price. In other words, at steps 3.4 and 3.5 of FIG. 3, a the coordination server could determine each of the routes, and assign a price to each route based on how quick the route is and how much it will increase congestion in the geographical area, and transmit these options to the smartphone. A user could then select their desired route and pay the fee for that route.

Other variables can also be used to assign priorities in some variants. For example, emergency vehicles (e.g. police cars, ambulances, fire engines etc.) responding to an emergency would automatically be designated a very high priority and provided with the quickest route to their destination.

The first embodiment discussed above provides a system and method for encouraging the use of alternative routes based on priority information, thereby reducing overall congestion. As a result, the occurrence of traffic jams is greatly reduced and the average travel time for users of the system is reduced. Furthermore, by reducing congestion, air quality in the geographical area (e.g. city) can be improved since there are fewer circumstances in which vehicles are static in traffic jams, resulting higher levels of pollution.

The system and method of the first embodiment can be adapted so as to have a greater focus on improving air quality. This will be discussed in detail in the second embodiment. While the first embodiment has a focus on congestion and the second embodiment has a focus on air quality, it will be apparent to the skilled person that any desired balance of these two objectives can be used instead, and that this balance can be varied dynamically (e.g. focus on reducing congestion during rush hour, and focus on improving air quality for the rest of the day).

In addition, as will also be discussed in the second embodiment, a number of features can be included to ensure compliance with the selected travel routes (i.e. to determine whether a user is actually following the route they have selected).

FIG. 5 shows a system 200 according to the second embodiment.

Similarly to the system 100 of the first embodiment, the system 200 of the second embodiment comprises a plurality of mobile devices 210a, 210b, 210c, 210d and a coordination server 250. The system 200 further comprises a pollution server 270. The plurality of mobile devices 210a, 210b, 210c, 210d and the pollution server 270 can all communicate with the coordination server 250 via the network 260. It will be appreciated that in practical implementations of embodiments of the invention there may be many such mobile devices, but four such mobile devices will be described in relation to FIG. 5 for ease of explanation.

The pollution server 270 is configured to provide pollution data to the coordination server. Specifically, the pollution server is configured to provide live pollution data (i.e. live emission data) for different sub-areas (e.g. individual roads) of a wider area (e.g. city). In this embodiment, the pollution data includes an overall pollution level for each sub-area. However, embodiments of the invention are not limited to this. It will be appreciated that in other embodiments of the invention, the pollution data could include individual levels of pollutants such as nitrogen dioxide, ozone, sulphur dioxide, PM10 particulates, PM2.5 particulates and/or any other suitable pollutant. In this embodiment, the pollution data is provided by an external service, such as BreezoMeter.

FIG. 6 shows more detail regarding one mobile device 210a of the plurality of mobile devices and the coordination server 250. Similarly to the mobile device 110a of the first embodiment, the mobile device 210a of the second embodiment comprises a communication interface 211, a GPS receiver 212, a user input unit 213 and a display 214. In addition, the mobile device 210a of the second embodiment comprises a camera 215 and a processor 216. The other mobile devices in the system 200 comprise equivalent components. However, embodiments of the invention are not limited to this. For example, in variants of this embodiment, only some of the mobile devices comprise a camera.

The communication interface 211 of the mobile device 210a is configured to communicate with the coordination server 250 via the network 260.

The GPS receiver 212 is configured to receive GPS data from a plurality of GPS satellites and to process the GPS data to determine a location of the mobile device. As also discussed with reference to the first embodiment, while the mobile device 210a comprises a GPS receiver, embodiments of the invention are not limited to this and any other suitable location-determination module could be used instead.

The input unit is configured to receive an input from a user of the mobile device 210a. In this embodiment the input unit 213 is a touch screen on the display 214. However, embodiments of the invention are not limited to this and any other suitable user input could be used instead.

The display 214 is configured to display information for the user of the mobile device 210a. Specifically, the display 214 is configured to display information regarding travel routes received from the server 250.

In this embodiment, the mobile device 210a is a smartphone, as are the other mobile devices in the system 100. However, embodiments of the invention are not limited to this any suitable mobile device could be used instead.

The coordination server 250 comprises a communication interface 251, a storage 252 and a processor 253. In this embodiment, the coordination server 250 is a single apparatus. However, embodiments of the invention are not limited to this and the server functionality of other embodiments could be provided in more than one connected apparatus.

The communication interface 251 of the coordination server 250 is configured to communicate with the pollution server 270 and the mobile devices 210a, 210b, 210c, 210d, via the network 260.

The storage unit 252 of the coordination server 250 pre-stores user information, including identification information regarding the user of each device, as well as their available modes of transport, and identification information for these modes of transport (number plate of the vehicle in this embodiment). As an example, the storage unit 252 may store information indicating that a user of a mobile device has a bicycle, petrol car, diesel car, hybrid car and/or electric car. In variants of this embodiment, the transport mode information is more specific, with exact emission levels per vehicle (e.g. emission levels provided by the manufacturer).

In this embodiment, this information is input by the user when they first register their mobile device with the server 250. However embodiments of the invention are not limited to this, and in other embodiments, this information could instead be transmitted from the user's mobile device to the coordination server each time it is needed. Alternatively, in some embodiment, the coordination server does not need to be provided with any transport mode information for specific devices. Instead, the coordination server could transmit all available transport routes to a mobile device and allow the user of that mobile device to select their route based on their available modes of transport.

The storage unit 252 of this embodiment also stores map data, including information such as speed limits for each of the roads in the map. In addition, the storage unit 252 stores congestion data, including the (actual or predicted) location and travel route of each of the mobile devices in the system. This information is received from the mobile devices, as discussed further later.

The processor 253 of the coordination server 250 is configured to process the information received by the communication interface 251 and the information stored in the storage 252, to generate travel routes for the mobile devices, and to determine whether the mobile devices are following the generated travel routes. This operation will be discussed in detail later.

The network 260 in this embodiment is the internet. However, embodiments of the invention are not limited to this and any suitable communication technology could be used instead.

The coordination server 250 is arranged to determine at least one travel route for at least one mobile device in the system. Specifically, the travel routes are determined so as to improve air quality in an area (e.g. city) in which the mobile devices are located. As will be discussed in detail, when determining the travel route for a mobile device in the system, the coordination server 250 uses location-related data of the mobile device (e.g. current location and destination), congestion data, pollution data from the pollution server 270, and priority related information (e.g. how many people are travelling together and the emission levels of their vehicle).

The operation of the embodiment discussed in relation to FIGS. 5 and 6 will be explained in relation to the flow chart of FIG. 7, which shows operations of the coordination server 250 with respect each mobile device in the system 200.

The method starts at step 7.1.

At step 7.2, the communication interface 251 of the coordination server 250 receives location-related data from a mobile device 210a. In this embodiment, the location related data is a current location of the mobile device 210a and a destination of the mobile device 210a.

At step 7.3, the coordination server 250 receives pollution data from the pollution server 270. The pollution data includes levels of pollution in the area between the current location of the mobile device 210a, and the destination of the mobile device 210a. While the pollution data is received at step 7.3 in this embodiment, the invention is not limited to this. For example, in other embodiments, the coordination server could first determine possible routes, and after this receive pollution data relating to these routes.

At step 7.4, the processor 253 of the coordination server 250 retrieves the map data and congestion data from the storage 252. The map data is data which is pre-stored in the storage 252. The congestion data includes a current (actual or predicted) location and/or travel route of each mobile device in the system. The acquisition and updating of the congestion data will be discussed later with reference to steps 7.7 and 7.9.

At step 7.5, the processor 253 of the coordination server 250 determines possible travel routes for the user of the mobile device to use to travel from their current location to their destination.

The coordination server 250 determines a plurality of possible routes between the current location of a mobile device and its destination, and assigns a priority level to each route. In this embodiment, the plurality of routes are determined using the map data and congestion data. For example, the four quickest routes may be found. Once these routes are determined, the processer 253 uses the pollution data to assign priorities for each route. The higher the pollution levels along a specific route, the higher the priority which may be required. For example, only high priority modes of transport may be permitted to use high priority routes.

In this embodiment, the priority for a device's (and therefore user's) mode of transport is based on an emission level per person (i.e. per device). For example, a diesel car with only one driver and no passengers would have a very high emission level per person and therefore would have a very low priority. In contrast, while a diesel bus may have higher emission levels than the diesel car, it would have a much lower emission level per person (assuming the bus is carrying a number of passengers) and therefore would have a much higher priority than the diesel car. In addition, an electric car would have a very high priority (with no emissions at all) irrespective of how many passengers inside. In other words, through the use of live pollution data to determine priorities for different routes, the processor 253 effectively creates dynamic virtual clean air zones (CAZ) at step 7.5.

At step 7.6, the server 250 transmits the determined routes, along with their priority levels, to the mobile device 210a. In this embodiment, the server 250 only transmits routes which are applicable to the available modes of transport for that user, stored in the storage 252. As a result, a user is only provided with relevant routes. However, as discussed above, in other embodiments of the invention, the server may not store information indicating available modes of transport for that user, and instead the server may transmit information regarding all possible routes to the mobile device, to allow the user to select an appropriate route.

After step 7.6, the user of the mobile device can then select which route to take (e.g. if they want to drive their diesel car without any passengers, they would have to follow a low priority route with low pollution levels so that they are not contributing to excessive pollution in any specific area). In this embodiment, the user selects their route using the user input unit 213 (i.e. touch screen) of their mobile device. The mobile device then transmits the selected route back to the coordination server 250 at step 7.7. The coordination server 250 uses this information to update the congestion data stored in the storage 252. In particular, the coordination server 250 updates the current location and current travel route of that mobile device.

At step 7.8, the server 250 receives compliance data from the plurality of mobile devices in the system. In this embodiment, there are two types of compliance data. However, in other embodiments only one of these types of compliance data may be used. Furthermore, in other embodiments, many other types of compliance data can be used in addition or instead. This will be discussed in detail later.

The first type of compliance data received is GPS data. After selecting a route and beginning to travel along that route, the mobile device 210a periodically transmits its GPS data to the server so as to ‘prove’ that it is travelling along the selected route. For example, the mobile device 210a may send its GPS data (i.e. data received by the mobile device 210a from GPS satellites) every thirty seconds. The processor 253 of the server 250 then analyses this data to determine a location of the mobile device and compares this to the selected route received from the mobile device, to determine whether the mobile device 210a is following the selected route.

The second type of compliance data received by the coordination server 250 relates to the cameras of other mobile devices. For example a mobile device may be positioned in the windscreen of a car, acting as a dashboard camera. The mobile device may capture images using its camera. The processor of the mobile device (or of a different devices such as a cloud server) then analyses the captured photographs using automatic number plate recognition (ANPR) technology so as to recognise number plates of other vehicles at that location. The mobile device then transmits its GPS data, together with this ANPR data, to the coordination server 250.

The coordination server 250 can use the ANPR data and GPS data from one mobile device to verify the GPS data (and therefore location) of another mobile device. In an example, the user of a first mobile device 210a selects to travel along a first route in their car, and their mobile device 210a periodically transmits GPS data to the coordination server 250 indicating that they are travelling along a first road on the first route. A second mobile device 210b is acting as a dashboard camera, and transmitting its GPS data to the coordination server indicating that it is travelling along a second road. The second mobile device 210b captures an image of the number plate of the car associated with the first mobile device 210a, and transmits this information to the coordination server 250. With this information, the coordination server 250 can determine that either the first mobile device 210a or the second mobile device 210b is incorrectly reporting its location, and not following its selected route. The second mobile device 210b may use machine vision to determine whether the car associated with the first mobile device 210a is parked or not parked (i.e. in motion or stopped but not parked), and may transmit the number plate information to the coordination server 250 only if it is determined that the vehicle is not parked.

The coordination server 250 could then use further information to determine which of the first and second mobile devices is not following its selected route. For example, ANPR-related data from other mobile devices may corroborate the information from the second mobile device 210b. In other words, a number of other mobile devices may also be travelling along the second road, and use their cameras to obtain ANPR-related data for either the vehicles associated with either the first or second mobile devices, thereby corroborating the information reported by the second mobile device 210b. As such, the coordination server 250 could determine that the first mobile device 210a was not correctly reporting its location, and not following its selected route.

In another example, the coordination server 250 could request further information from either the first mobile device 210a or the second mobile device 210b to verify their reported locations. For example, the user may be required to capture an image of a road sign, or a specific landmark on their route.

Based on this information, the coordination server 250 can then update the congestion data stored in the storage 252. For example, if the coordination server determines that the first mobile is actually driving along the second road rather than the first road, the congestion data could be updated to indicate that the vehicle associated with the first mobile device is actually on the second road, not the first road.

In a variant of this embodiment, when analysing the captured photographs using ANPR to recognise number plates of other vehicles, the processor of the mobile device (or of a different device such as a cloud server) assigns a confidence value to the result of the analysis. The confidence value can be based on the image quality of the captured photographs (e.g. the resolution of camera used for photographing). Alternatively, or additionally, the confidence value can be based on imaging conditions. For example, a result determined from a dark image (e.g. at night) may have a lower confidence than a result determined from a light image (e.g. during the day).

In another variant, the coordination server determines a confidence value based on how many ANPR ‘hits’ are received from different mobile devices. For example, if the coordination server receives ANPR data from two separate mobile devices, both recognising the same number plate in the same or similar position at the same or similar time (e.g. on the same road within two minutes of each other), then the coordination server assigns a higher confidence level to the determination that a vehicle with that number plate was at that positon at that time, than if only one mobile device had reported this.

In some variants, when using a confidence level of number plate recognition (based on image quality, image conditions, and/or number of hits), the coordination server has a predetermined threshold confidence level which must be reached before the coordination server determines that a vehicle with the recognised number plate was at a particular position at a particular time. For example, the threshold confidence level could correspond to two high quality images from two separate mobile devices or four low quality images from four separate mobile devices.

In another variant, the ANPR data is instead used to determine a mode of transport. For example, a user may select a route, informing the coordination server that they are driving in an electric car, but actually take their diesel car. Based on the ANPR data acquired by other user's mobile devices, the coordination server would be able to identify that the user had instead taken their diesel car. In this example, the mobile device (or other device such as a cloud server or the coordination server) transmits a request including a recognised number plate to an external vehicle database, and receives information (e.g. make, model, colour, emission information etc.) regarding the vehicle associated with that number plate from the database. In another example, this vehicle information can be stored at the coordination server.

Through the above analysis of pollution data and compliance data, the coordination server 250 is able to dynamically create, alter, and monitor compliance of a virtual clean air zone, based on the current air quality level in each zone.

By using live pollution data in the second embodiment of this invention, as discussed above, the coordination server 250 can determine when to dynamically implement virtual clean air zones at the most appropriate places and times. Furthermore, the use of compliance data from user's mobile devices (e.g. by using their GPS data and cameras), allows the virtual clean air zones to be implemented as a software solution. Since no physical infrastructure is needed (i.e. there is no need to install fixed enforcement cameras), this system can be implemented without the conventional start-up costs. Furthermore, since there is no need to install fixed physical infrastructure, this system can be implemented anywhere, at any time. For example the system could ‘pop up’ around a large music festival even in a remote area

In a variant of this embodiment, the coordination server can assign different priorities to different parts of a route (rather than just one priority for the entire route). For example, if a first part of a route has low pollution levels as indicated by the live pollution data (e.g. roads in the countryside), but the second parts of the route has high pollution levels (e.g. travelling into a city), the coordination server can assign a low priority to the first part of the route, and a high priority to the second part of the route.

Hence, a user would be permitted to use a low priority mode of transport for the first part of the route, but must use a high priority mode of transport for the second part. For example, a user could drive their diesel car for the first part of the route, and then take a bus or car-pool for the second part of the route. Alternatively, if a user had an electric car, they could drive the entire route.

In this example (i.e. a low priority first part of the route and a high priority second part), if the user had a hybrid vehicle, they could drive the first part of the route using the combustion engine, but be required to use the electric mode of the hybrid vehicle for the second part of the route. In this case, the user's mobile device may also comprises a microphone and accelerometer. The compliance data (i.e. the compliance data sent from the mobile device to the coordination server at step 7.8) includes accelerometer and microphone data. This data provides information regarding the sound and vibration of the vehicle in which the mobile device is travelling. Based on the sound and vibration levels, the coordination server can determine whether or not the hybrid vehicle is operating in its electric mode (i.e. determine its operational mode), and therefore whether the user is complying with the selected route to its destination. In a variant of this embodiment, the determination could instead be made by the mobile device or the vehicle.

In some variants, the system could also include a number of driverless cars. For example, an inner city may have a number of driverless electric cars. When a mobile device transmits its current location and destination to the coordination server, the server may provide the option of being taken in a driverless car, which can then be sent to the current location of the mobile device.

In another variant of this embodiment, the coordination server can use the data from the pollution server to determine clean air routes. In other words, the coordination server can suggest a route for a user to take which has low pollution levels. This is particularly beneficial for modes of transport such as cycling, as well as for users with health issues for which high pollution levels can be dangerous.

In another variant, further compliance data can be used to determine whether a user is complying with a selection to take part in a car-pool. For example, a user may be required to use the camera of their mobile device to capture an image or video of each person in the vehicle, thereby proving that they are taking part in a carpool. In some variants, the coordination server algorithmically requests this, rather than requiring it for every journey. For example, previous offenders may be challenged more than others.

Alternatively, each person in the vehicle could be required to talk into a microphone of a mobile device, thereby proving that they are all present. Another option is for the coordination server to compare the GPS data received from each of the mobile devices that are supposed to be taking part in a car-pool, and determining whether they correspond to each other. A further options is to request that the user's use their mobile devices to perform a near filed communication (NFC) ‘digital handshake’, thereby proving that they are in close proximity with each other.

While both of the first and second embodiments have been discussed with reference to people (i.e. number of people per vehicle and emission levels per person), embodiments of the invention are not limited to this. In some embodiments, priority levels can instead be determined based on amount of goods (e.g. weight of goods). In other words, goods vehicles can have a priority level assigned based on ‘weight of goods per vehicle’ or based on ‘emission levels per weight of goods’. Such priority levels can be used instead of the ‘people’ priory levels, or integrated. As an example, the priority level of a vehicle with five in could be the same as the priority level of a vehicle with a 500 kg worth of goods to be delivered. Furthermore, the coordination server could offer alternatives. Examples include consolidate goods for multiple deliveries, or deliver at a different time.

As also discussed with reference to the first embodiment, in variants of this embodiment, users can choose to pay to increase their priority level. For example, if a user was driving a diesel car with high emissions (and therefore low priority), they could choose to pay (e.g £1) or to pick up a carpooler to increase their priority level to be equivalent to that of an electric car and therefore sufficient to travel along a high priority route.

The cameras of the mobile devices can also be used for other purposes in some variants of this embodiment. For example, while acting as dashboard cameras, the cameras of the mobile devices will constantly be capturing images of parking spaces that the mobile device is travelling past. These can be analysed (either by the individual device or the coordination server) to identify available parking spaces. The coordination server can then incorporate this information into its route planning. For example, a user may only be given the option of driving to a particular destination if a parking space is available. If not, the route would take the user to a nearby destination where they can park, and then a different mode of transport (e.g. walking or public transport) would be used to get to the final destination.

By using this method of directing a user directly to a parking space, the need for vehicles to spend time driving around looking for parking spaces is reduced. As such, levels of pollution from the vehicles can be reduced, thereby improving air quality. In addition, since this reduces the overall time that vehicles spend travelling, this also contributes to a reduction in congestion.

Furthermore, in some variants, this camera data can be used to enforce parking and traffic violation. For example, if by combing the camera data from a number of different mobile devices at different times, the duration for which a car has been parked in a particular space can be monitored. In addition, the camera data could, for example, be used to determine whether another vehicle has travelled through a red traffic light.

In some variants, the updated congestion data can be used to identify incidents, and coordinate traffic around such incidents. For example, if the congestion data shows a queue of vehicles leading up to a single point, and not moving past this point, this may indicate that an incident has occurred at that point, and the coordination server can direct traffic around the incident.

Furthermore, in some embodiments mobile devices associated with emergency vehicles are included in the system. As such, the coordination server can direct other traffic away from the routes being followed by the emergency vehicles, so as to allow the emergency vehicles to reach the incidents as quickly as possible. In addition, the coordination server can minimise overall congestion by directing all users around the incident.

While the use of compliance data to verify the routes being taken by mobile devices has been discussed with reference to the second embodiment (focused on air quality), it will be appreciated this compliance data (e.g. GPS and ANPR information) is equally applicable to the first embodiment (focused on congestion).

Furthermore, while the first and second embodiments have been discussed separately (one focused on congestion and one focused on air quality), it will be appreciated that both embodiments in fact result in a reduction of congestion and an improvement in air quality (assuming the system comprises pollution-emitting vehicles).

Furthermore, it will be appreciated that the present invention can (and in practical implementations often will) be implemented with any desired balance between congestion and air quality. In one example, the priority level can be calculated using Equation 1:

Route priority=W₁*(number of people per vehicle)+W₂*(emissions per person) [Equation 1]

By increasing the value of congestion weighting W₁, the focus on congestion can be increased, whereas by increasing the value of pollution weighting W₂, the focus on air quality can be increased.

Furthermore, the balance between congestion and air quality can be dynamically changed in some embodiments of the invention. For example, this dynamic change could be based on timings. During rush hour, the focus could be placed on congestion, whereas for the rest of the day, the focus could be placed on air quality.

Alternatively, the dynamic change could be based on other factors. For example, the coordination server may determine (based on the routes selected by users of the mobile devices, as well as the congestion data), that there are a large number of pedestrians and/or cyclists in a particular area. As a result, the focus of the system for this area could be placed on air quality, by increasing the pollution weighting W₂ of Equation 1 for that area. In other areas there may be very few pedestrians and a large number of vehicles. As a result, the server could determine that congestion is most important in that area, and therefore increase the value of the congestion weighting W₁.

In other words, in different areas and at different times, the coordination server can determine whether to implement a virtual congestion zone, a virtual clean air zone, or a balance of the two, by adjusting the congestion weighting W₁ and the pollution weighting W₂.

While Equation 1 has been provided as an example, it will be appreciated that there are many other suitable methods for determining which users and modes of transport can be permitted to use certain routes so as to improve air quality and reduce congestion. In addition, it will be appreciated that in practical implementations of embodiments of the invention, the algorithm used is likely to include more factors than those in Equation 1 (such as also including emission levels per goods, or amount of goods per vehicle).

In some embodiments, the coordination server uses a Zero-Proof Blockchain, allowing the server to follow rules without having specific access to data.

As discussed in the above embodiments, the present invention provides a system and method for dynamically controlling congestion and air quality in geographical areas, such as cities, by dynamically determining suggested/permitted routes for different users and different modes of transport.

Through the use of data provided by user's mobile devices (e.g. GPS data and camera data), the system can ensure compliance with determined travel routes, without the need for any physical infrastructure. In contrast to conventional congestion zones and clean air zones which require significant upfront and maintenance costs to install and maintain, the system and method of embodiments of the present invention can dynamically create and modify virtual clean air zones and congestion zones with much lower infrastructure costs. In other words, embodiments of the present invention can be implemented entirely through the use of software and pre-existing hardware and are therefore significantly cheaper and more dynamic than conventional systems.

It will be understood that the present invention has been described above purely by way of example, and modifications of detail can be made within the scope of the invention.

Reference numerals appearing in the claims are by way of illustration only and shall have no limiting effect on the scope of the claims.

1. A method comprising:
receiving a current location and a planned destination from a plurality of mobile devices;
planning travel routes for each of the plurality of mobile devices, based at least on the current locations and planned destinations, that reduce congestion and/or improve air quality in a geographical area, and
communicating the planned travel route to the associated mobile device.

2. The method of claim 1, further comprising planning more than one travel route for each of the plurality of mobile devices and assigning a priority level to each planned route.

3. The method of claim 2, further comprising receiving information indicating modes of transport of the plurality of mobile devices,
wherein the assigning the priority levels is based on the modes of transport.

4. The method of claim 2 or claim 3, further comprising receiving air quality information for the geographical area from an air quality server,
wherein the assigning the priority levels is based on the air quality information.

5. The method of any one of claims 2 to 4, wherein the priority level for each planned route indicates a required minimum number of people per vehicle for that route.

6. The method of any one of claims 2 to 5, wherein the priority level for each planned route indicates a maximum emission level for a vehicle for that route.

7. The method of any preceding claim, further comprising receiving compliance data from the plurality of mobile devices; and
determining whether a mobile device is following a permitted route based on the compliance data.

8. The method of claim 7, wherein the compliance data comprises location-related data received at the mobile device.

9. The method of claim 7 or claim 8, wherein the compliance data comprises information relating to images captured by at least one of the plurality of mobile devices.

10. The method of any of claims 7 to 9, wherein the compliance data comprises microphone and/or accelerometer data from the plurality of mobile devices.

11. The method of any of claims 7 to 10, wherein the determining whether the mobile device is following the permitted route is based on compliance data received by the coordination server from another mobile device from among the plurality of mobile devices.

12. The method of claim 11, wherein the compliance data received from the another mobile device comprises information indicating that the another mobile device has identified a vehicle associated with the mobile device near to a location of the another mobile device.

13. The method of claim 12, wherein the compliance data comprises automatic number plate recognition, ANPR, data.

14. The method of claim 13, further comprising assigning a confidence level to the compliance data for the mobile device based on a quantity of ANPR data corresponding to the mobile device

15. The method of any preceding claim, further comprising determining a preferred operational mode for driving a vehicle along the planned route for at least one of the plurality of mobile devices.

16. The method of claim 15 when dependent on claim 10, further comprising determining whether the vehicle is operating in the preferred operational mode based on the microphone and/or accelerometer data.

17. The method of any preceding claim, further comprising receiving, from one of the plurality of mobile devices, traffic information comprising an identity and approximate location of one or more vehicles, the traffic information being derived from an image captured by the mobile device; and
updating the planned travel routes based on the current location of the mobile device and the generated traffic information.

18. The method of any preceding claim, further comprising receiving parking space information indicating a location of an available parking space from a first mobile device from among the plurality of mobile devices, the parking space information being derived from an image captured by the first mobile device, and
setting a final destination of a planned travel route for a second mobile device from among the plurality of mobile devices as the location of the available parking space.

19. A computer-implemented method comprising:
in response to receiving, by a mobile device, location information for a target destination, requesting, by the mobile device from a server, navigation information for driving a vehicle to the target destination, the navigation information including route information and operation information indicating a preferred operational mode for the vehicle; and
in response to receiving the navigation information, collecting, by the mobile device, compliance data indicating compliance of the vehicle with the navigation information and transmitting the compliance data from the mobile device to the server.

20. The method of claim 19, wherein collecting the compliance data comprises detecting, by the mobile device, a location of the mobile device.

21. The method of claim 19 or claim 20, wherein collecting the compliance data comprises detecting, by the mobile device using a microphone and/or accelerometer of the mobile device, an active operational mode of the vehicle.

22. A computer-implemented method comprising:
detecting, by a mobile device, a current location of the mobile device;
capturing an image, using a camera of the mobile device;
generating, by the mobile device from the captured image, traffic information comprising a determined identity and approximate location of one or more vehicles in the captured image;
transmitting, by the mobile device to a server, the current location of the mobile device and the generated traffic information; and
requesting, by the mobile device from the server, updated navigation information based on the current location of the mobile device and the generated traffic information.

23. A computer-implemented method comprising:
detecting a current location of a mobile device;
capturing an image, using a camera of the mobile device;
determining an approximate location of a parking space in the captured image;
determining, based on the current location of the mobile device, and the approximate location of the parking space in the image, the physical location of the parking space.

24. Apparatus configured to perform the method any of one of claims 1 to 23.

25. A computer program comprising machine-readable instructions which, when executed by computing apparatus, cause it to perform the method of any of claims 1 to 23.

26. Apparatus configured to:
receive a current location and a planned destination from a plurality of mobile devices;
plan travel routes for each of the plurality of mobile devices, based at least on the current locations and planned destinations, that reduce congestion and/or improve air quality in a geographical area, and
communicate the planned travel route to the associated mobile device.

27. Apparatus configured to:
in response to receiving, location information for a target destination, request from a server, navigation information for driving a vehicle to the target destination, the navigation information including route information and operation information indicating a preferred operational mode for the vehicle; and
in response to receiving the navigation information, collect compliance data indicating compliance of the vehicle with the navigation information and transmitting the compliance data to the server.

28. Apparatus configured to:
detect a current location of the apparatus;
capture an image, using a camera of the apparatus;
generate, from the captured image, traffic information comprising a determined identity and approximate location of one or more vehicles in the captured image;
transmit, to a server, the current location of the apparatus and the generated traffic information; and
request, from the server, updated navigation information based on the current location of the apparatus and the generated traffic information.

29. Apparatus configured to:
detect a current location of the apparatus;
capture an image, using a camera of the apparatus;
determine an approximate location of a parking space in the captured image;
determine, based on the current location of the apparatus, and the approximate location of the parking space in the image, the physical location of the parking space.
